(19) United States
(12) Patent Application Publication
(10) Pub. No.: US 2008/0243659 A1
(43) Pub. Date: Oct. 2, 2008

(54) ELECTRIC STATEMENT PREVIEWING SYSTEM AND METHOD

(75) Inventors: William Hickox, Omaha, NE (US); Steven Craig Blodgett, Elkhorn, NE (US); Marcia Lee Workman, LaVista, NE (US); David Michael John O'Meara, Bellevue, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/692,853

(22) Filed: Mar. 28, 2007

(51) Int. Cl. G06Q 40/00

(52) U.S. Cl. 705/35

(57) ABSTRACT

A system for preparing and delivering credit card statements to cardholders is operated by a credit card processing entity, and includes a statement processing system and a statement preview system. Statements are previewed by a card issuer after providing statement selection criteria to the preview system. After any requested corrections are made to the previewed statements, the statements have encryption and delivery options applied, and are then electronically transmitted to cardholders.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

Millions of merchant transactions involving electronic records occur daily throughout the world. One common type of transaction involves the use of a presentation instrument, such as a credit card, a debit card, and the like. When such a presentation instrument is used to make a purchase, information stored on the card may be read by a point-of-sale device which creates an electronic record of the purchase. In the case of credit cards, the information read by the point-of-sale device along with the amount of the purchase is routed through various other entities in order to complete the purchase. For example, the transaction information may be electronically sent to a transaction processing entity, to the merchant's bank or financial institution, to a card holder association (such as VISA® or MasterCard®), and to the issuer's bank or financial institution.

Periodically, cardholders are billed and receive a statement from the card issuer for transactions. The advancement of information technology has expanded the available options for credit issuing organizations to send statements to cardholders, such as the electronic transmission of statements.

In some instances, a transaction processing entity prepares statements on behalf of a card issuer. However, because credit card terms (standard and promotional interest rates, credit limits, balance transfer terms, minimum payment requirements, etc.) can be complex and vary widely among cardholders, the issuer often will need to conduct at least a periodic preview or sampling of statements prepared by the processing entity before being transmitted to cardholders, to make sure the proper credit card terms are being used.

With electronic statements, previewing can be difficult. For example, statements are often transmitted to cardholders using encryption, security and delivery features. The handling of these features during previewing can add time and complexity to the process. Furthermore, because a large number of statements may be available for preview, the previewing system must be sufficiently flexible to permit the issuer to chose criteria and parameters for statements to be previewed, so that the previewing process does not present a large burden on the issuer or add unnecessary delay to the cardholder's receipt of the statement.

### BRIEF SUMMARY OF THE INVENTION

There is provided, in accordance with embodiments of the present invention, a system and method for previewing statements prepared by a transaction processing entity on behalf of a card issuer or other financial institution, where the statements are previewed by the financial institution prior to electronic transmission to a customer or cardholders

In one embodiment, a method includes providing a statement processing system, the statement processing system being operated by the transaction processing entity, preparing electronic statements at a statement processing system, providing a statement previewing system in communication with the statement processing system for the issuer to access the statements prior to being prepared with security (e.g., encryption) and delivery features, providing preview criteria to the previewing system, the criteria defining a group of statements that are to be previewed by the issuer, providing access to the group of statements for the issuer at the previewing system, providing correction data from the issuer to the previewing system if corrections to the group of statement are required, preparing corrected statements at the statement processing system if correction data has been provided to the previewing system, and electronically transmitting the group of statements to cardholders with the security and encryption features.

A more complete understanding of the present invention may be derived by referring to the detailed description of the invention and to the claims, when considered in connection with the Figures.

### BRIEF DESCRIPTION OF THE DRAWINGS

FIG. 1 is a general block diagram showing a credit card statement processing network according to embodiments of the invention.

FIG. 2 is a flow diagram illustrating the preparation, preview and transmission of statements, according to one embodiment of the invention.

FIG. 3 is illustrates a screen displayed at the card issuer computer and used for entering selection criteria prior to previewing statements.

FIG. 4 illustrates another screen displayed at the card issuer computer and used when previewing statements.

FIG. 5 illustrates yet another screen displayed at the card issuer computer and used when correcting previewed statements.

### DETAILED DESCRIPTION OF THE INVENTION

Credit services may be established with essentially any type of person, entity, organization, business, or the like that wishes to take payments for goods or services in the form of a credit. For convenience of discussion, such entities are generally referred to herein as “merchants.” Merchants may process a credit transaction based on an account identifier presented at the time of payment. The account identifier is used to identify the account to which the credit will eventually be posted. In many cases, the account identifier is provided on some type of presentation instrument, such as a credit card, debit card, smart card, stored value card, RFID (radio frequency identification) device, or the like. Conveniently, the account identifier may be read from a point-of-sale device, such as those described in copending U.S. application Ser. No. 10/116,689, entitled “SYSTEMS AND METHODS FOR PERFORMING TRANSACTIONS AT A POINT-OF-SALE,” filed Apr. 3, 2002, by Earney Stoutenburg, et al., the complete disclosure of which is herein incorporated by reference. However, the account identifier may be obtained in other ways, such as by visual inspection of the presentation instrument, by telephone, over the Internet, and the like.

The user account information is transmitted to a credit card or transaction processing service that approves and processes the transaction information and provides payment to the merchant. The transaction processing service includes at least one platform server that receives and processes the transaction information. One example of a credit card processing service is the service provided by First Data Corporation, Greenwood Village, Colo.

An entity providing processing services may do so not only for merchants, but also financial clients, such as banks and the like, that establish accounts and issue credit cards to their customers. These clients of the processing entity are hereinafter referred to for convenience as “issuers,” although it should be appreciated that depending on the circumstances, the client may be an organization or business other than a traditional “card issuer.”

Periodically, the processing entity produces statements on behalf of the issuer that summarize transactions for customers and bill the customers at least a minimum amount based upon their usage of the credit account. The statements must be presented to the customer so that the customer may render payment. In many cases, the financial statement is prepared by the credit card processing entity, and sent through the mail or electronically to the customer by the processing entity on behalf of the issuer. A more detailed description of the preparation and transmission of statements to cardholders can be found in co-pending and commonly assigned U.S. application Ser. No. 10/180,251, entitled “FINANCIAL STATEMENT PRESENTMENT SYSTEMS AND METHODS,” filed Jun. 25, 2003, by William Hickox, et al., the complete disclosure of which is herein incorporated by reference. The present invention provides systems and methods for enabling the issuer to preview such statements, i.e., review the statements prior to being sent to the cardholders

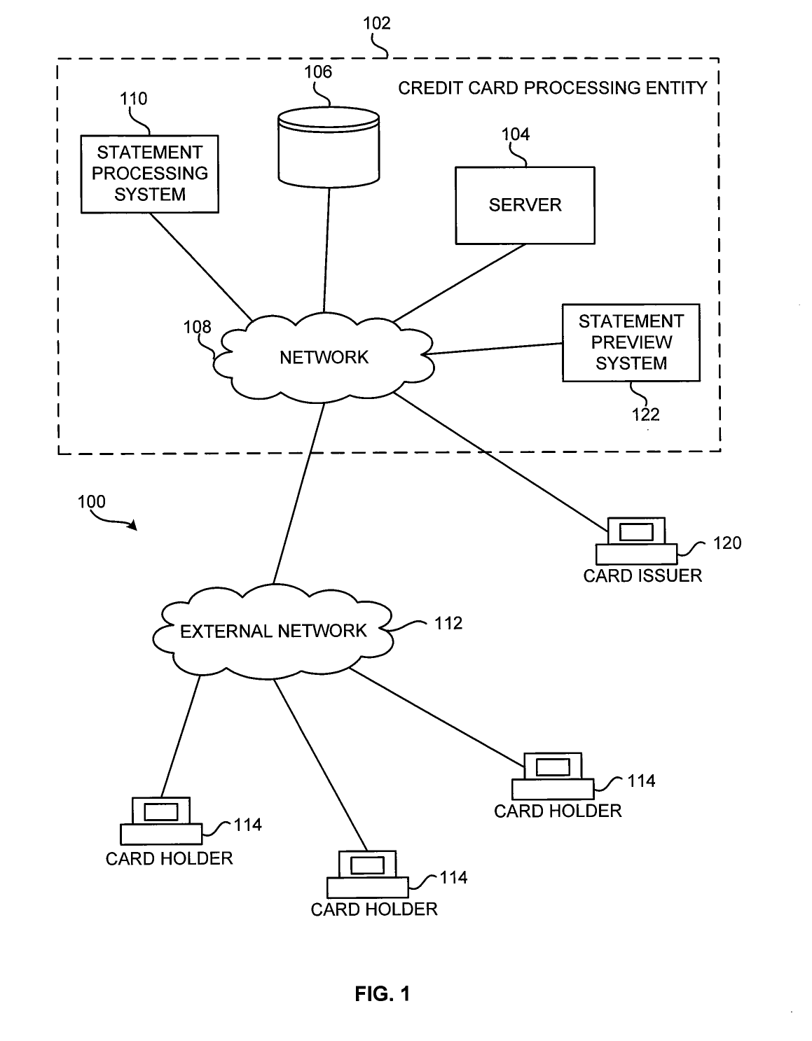

FIG. 1 illustrates one example of a network/system 100 for preparing, previewing and transmitting (to cardholders) statements according to embodiments of the present invention. It is to be understood that the network 100 is presented for illustrative purposes only and many other embodiments and equivalents will be apparent to those skilled in the art in light of the disclosure herein. The network 100 includes a host computer system 102. The host computer system 102 is operated by a card processing entity in some embodiments, and includes a server 104 and a database 106 associated with the server 104. The server 104 may be any of a wide variety of well-known computing devices, including, for example, a personal computer, a workstation, a mainframe, and the like. The database 106 may be any of a wide variety of storage devices, including, for example, magnetic storage systems, such as tape or disk, optical storage systems, such as CD or DVD systems, and solid state systems, such as RAM or ROM, and the like. For purposes of storing and processing data at the database 106, the server 104 may be connected for communication directly to the database 106. Alternatively or additionally, the server 104 and database 106 may communicate via an internal network 108. The network 108 may be any of a wide variety of network configurations, such as, for example, an intranet or a portion of the Internet. The network 108 may be, for example, a local area network (LAN), a wide area network (WAN), or the like. The host computer system 102 may also include a financial statement processing system 110. The statement processing system 110 may be any of a wide variety of well known computing devices. It may be connected to the server 104 directly or via the network 108. Many additional computing and data collection platforms (not shown) may be connected with the host computer system 102 and/or be comprised by portions of it. Furthermore, while the various computing and storage systems within host system 102 are illustrated (for purposes of the present description) as separate from each other, it should be appreciated that any or all of such systems may be integrated into a single system within host system 102, and appropriately programmed to carry out the functions described herein.

FIG. 1 also illustrates an external network 112 connected with the host computer system 102. The external network 112 may be, for example, the Internet. Through the external network 112, customers or cardholders are able to communicate with the host computer system 102 using, for example, cardholder computers 114. Additionally, clients are also able to communicate with the host computer system 102 using, for example, a client or card issuer computer 120. While the card issuer computer 120 is illustrated as communicating directly with the host computer 102 via the network 108 (e.g., via a secure dedicated link), alternatively computer 120 may communicate through external network 112 with proper security techniques in place.

For further details on the network 100 as thus far described, reference can be made to the previously referenced application Ser. No. 10/180,251.

In accordance with some embodiments, FIG. 1 also illustrates a statement preview system 122 connected to network 108. The preview system will be described in greater detail later. However, briefly, system 122 enables the card issuer to preview statements or groups of statements selected by the issuer and prior to being sent to cardholders.

Having described the configuration of the network 100, the general operation of such network will now be described (more specific operations will be described later with reference to the remaining Figures).

Initially, financial transaction information is collected and stored using computers and storage devices associated with the host computer system 102. Periodically, the financial transactions are processed into statements for each customer or cardholder by the statement processing system 110. Cardholders may have various options relating to how to receive their financial statements (e.g., electronic, paper or both), although the described embodiments herein are directed to situations where such statements are transmitted electronically to cardholders.

At predetermined points in time (e.g., the end of billing cycles for respective cardholders), the server 104 directs the statement processing system 110 to prepare statements corresponding to those cardholders or their accounts, at which time the system collects and processes data (e.g., stored in database 106) for those accounts in order to prepare statements. The server 104 notifies the issuer computer 120 (e.g., via email) of the availability of such statements. At that time (or, if desired by the issuer, at a earlier point in time), the issuer provides selection criteria to the preview system 122, with parameters or criteria for those statements which the card issuer desires to select for preview. An employee of the card issuer at computer 120 accesses the statement preview system 122, which collects and transmits the group of selected statements for the issuer. The issuer then previews the selected statements.

After previewing and approval by the issuer, the server 104 causes an email to be transmitted to the cardholders at computers 114. As examples, the statement for each cardholder may be attached to the email, or the email may contain a link to a website operated by the processing entity in order for the cardholder to view his/her statement. In addition to receiving and viewing the electronic statement, the cardholder may chose a payment process through the same website for paying the amount owned, such as authorizing an electronic transfer of funds from a financial account of the cardholder to a financial account of the issuer.

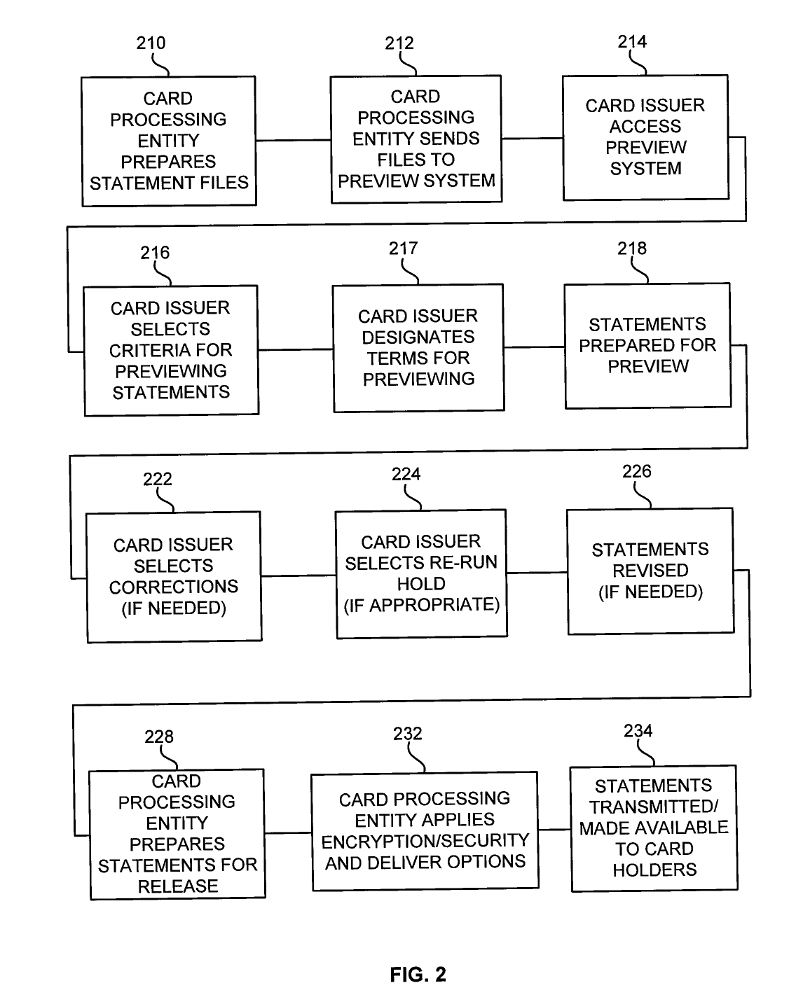

Referring to FIG. 2, a more detailed description of the statement preparation, preview, and transmission process will now be described. When a billing cycle ends (e.g., on a specified day each month) for a group of cardholders, the statement processing system 110 (e.g., under the control of server 104) retrieves all transaction data from that billing cycle for each of those cardholders from database 106, and prepares a statement for each cardholder in the form of an electronic statement file (step 210). The statement file contains all information for displaying a statement to the respective cardholder at the cardholder computer 114. However, for reasons that will be explained later, the statement file is not encrypted or reformatted to accommodate delivery features for the cardholder, since the statement at this point is not being sent over unsecured transmission facilities to the cardholder, rather it will only be accessed by the issuer for previewing.

The server 104 then causes the statement processing system to send each statement file to the statement preview system 122 (step 212). While not seen in FIG. 2, the server 104 may send an email to the card issuer that the statements for the relevant group of cardholders is available for previewing. The card issuer then accesses the preview system 122 (step 214), and selects the sorting or searching criteria to be used in determining which statements will be previewed (step 216). As examples, the issuer may select random statements (request the previewing system provide a sampling of random or representative statements), select every nth statement (“n” may be any integer, thus, e.g., every the 10th statement, 50th statement, etc.), select only statements from accounts that are delinquent or overdue, select by account characteristics (account holder zip code, city, state, etc.), select by account terms (only accounts that have interest rates at or within designated ranges—e.g., below 10%, between 10% and 15%, above 20%), select only new accounts, and so forth.

Although not seen in FIG. 2, in some embodiments statements may be presented to the issuer in batches, to which the sorting criteria in step 216 may then be applied. For example, an issuer may have multiple card programs (e.g., each card program using a different brand or each marketed to different groups of consumers). Prior to selecting sorting criteria, the issuer may select one of more batches to be previewed. Each batch may have thousands or even millions of card accounts (e.g., all statements in a batch may have a common brand), and after a batch is selected, the issuer is then given the opportunity to select sorting criteria (step 216) in order to reduce the number of statements in the batch to a reasonable number that can be previewed.

In addition to selecting sorting criteria for statements to be reviewed, the issuer may also designate the terms of previewing (step 217). The terms of previewing may provide different forms of conditional access to the statements. As an example, the issuer may specify that all statements to be previewed are approved by default if they are not flagged for correction within a specified period of time (e.g., one day) after available for preview. Alternatively, the issuer may specify that statements are to be automatically released to cardholders without previewing (e.g., for that one billing cycle only, or for more than one billing cycle), or that statements may only be released to cardholders after individually approved (and thus put on hold until such approval). Depending on the designations, step 217 can be either in addition to or in lieu of the issuer making section criteria at step 216.

At step 218, the statement processing system sorts statements according to the criteria provided at step 216, so they may be viewed by the issuer at computer 120. The card issuer selects statements that are in need of correction (step 222). In addition, the issuer may optionally specify that the corrected statement(s) are to be held (from release) until they have been re-run and approved (step 224), otherwise they are released and made available to the cardholder after the corrections are made. The statements are then corrected and re-run (step 226), and they are prepared by the statement processing system for release and distribution to cardholders (step 228). At step 232, the card processing entity applies the appropriate encryption and security measures to the statement (e.g., to prevent authorized access during transmission to the cardholder using standard encryption techniques such as symmetric or asymmetric encryption), and applies delivery features (e.g., an email is prepared to which the statement is an attachment, or an email is prepared with a link to a website where the statement may be accessed by the cardholder). The statements are then electronically transmitted (e.g., via email) or made available (e.g., via a website) to the cardholders (step 234).

The previewing of statements prior to the application of encryption/security/delivery features has the advantage of simplifying and speeding up the previewing process. For example, by previewing prior to encryption, the previewing system need not go through the step of decrypting statements prior to displaying to the issuer, and thus they may be provided more quickly to the previewing system 122.

While not illustrated in the drawings, an issuer may use a conditional access in the form of a hierarchical previewing and approval process. That is, when the statements are accessed at the card issuer computer 120, the employee viewing them may request corrections or approve, but the previewing system 122 may be programmed to hold the statements (without making requested corrections and without releasing to cardholders) until another person of higher authority also provides corrections or approvals. The previewing system 122 may also attach any comments of issuer employees to statements that have been previewed, so that each person in the hierarchy may comment on any previewed statement, with the comments displayed for the next, higher person in the hierarchy. A higher person in the hierarchy can thus see comments of subordinates before that person himself/herself requests corrections or approves the statement.

Also, if the system provides for multiple levels of approval, the system may provide that the employee viewing and approving any statements (a lower level employee) is not able to put a statement in a re-run status (step 226) without first being reviewed by a specified person that is higher in the hierarchy.

The process seen in FIG. 2 is but one example of a steps that can be implemented using the system of FIG. 1. It should be appreciated that in other embodiments, steps may be added, some steps may be omitted, and the order of the steps may be changed. As one example, and as mentioned earlier, the previewing could include an additional step whereby batches of statements are identified and then selected by the issuer, prior to the issuer selecting sorting/searching criteria for the individual statements to be viewed. As another example, the processing entity could optionally place a global hold on all statement releases, and the process of FIG. 2 could include a decision point (not illustrated) for making sure such a global hold is not in place before preparing statements for release (step 228). Such a global hold might be desirable for the processing entity, for example, (1) if it discovers a software system anomaly causing errors in the preparation of cardholder-viewed statements, and the processing entity wants no statements made available to cardholders until the anomaly is corrected, or (2) the processing entity is updating software within system 110 and wants no statements made available to cardholders until the update is completed. As yet another example of additional steps, the system 110 may be programmed to monitor the time it takes for the issuer to access the system at step 214. For example, an email alert may be sent to the issuer after a predetermined amount of time has elapsed from the point at which the statements are available for preview (step 212) but still not approved. The alerts may escalate as the amount of time increases (after 3 days, after 5 days, after 7 days, etc.), since the availability of the statements to cardholders is being correspondingly delayed. Similar alerts may be sent to personnel within the processing entity.

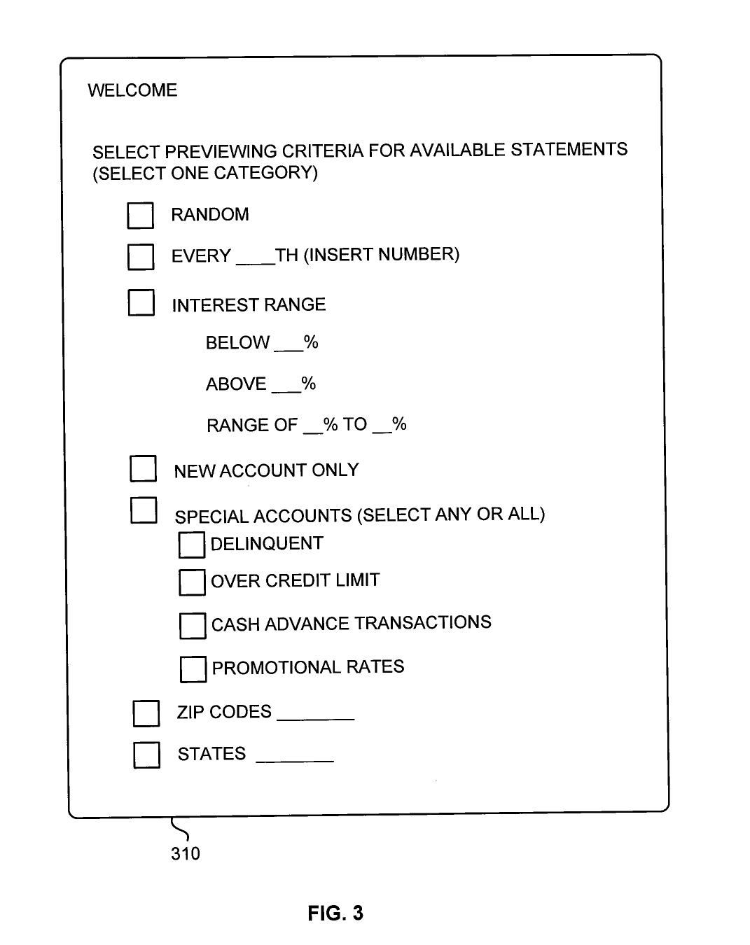

FIG. 3 illustrates a screen 310 displayed at the card issuer computer 120 (FIG. 1) when the statement preview system has been accessed in order to preview statements (steps 214, 216 in FIG. 2). As can be seen, screen 310 permits the issuer to select the criteria that will be used to sort statements for previewing. The various criteria that are illustrated for selection at screen 310 are exemplary only, it being understood that other criteria may be used depending on the needs/desires of the issuer.

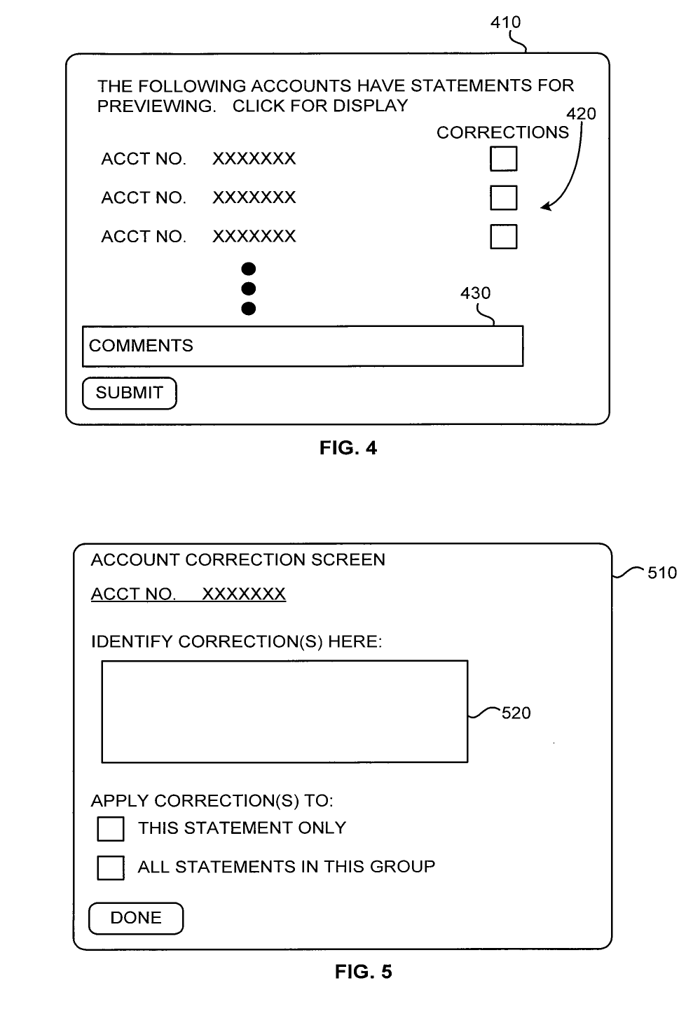

FIG. 4 illustrates a screen 410 that is displayed at the card issuer computer 120 after statements have been sorted and made available to the issuer in accordance with the criteria entered at screen 310 in FIG. 3. The issuer selects an individual statement for viewing by clicking (selecting) that statement. If after viewing a statement, corrections are needed, that statement is flagged by marking the corresponding one of the correction boxes 420.

In addition, an employee of the issuer that is previewing a statement may enter comments at a box 430. Comments can be used for various purposes. As an example, a comment may point out particular aspects of a previewed statement that should be closely looked at by others because of questions or concerns, such as when there is a hierarchical previewing and approval process as described earlier, so that the questions or concerns will be seen by others subsequently previewing the statements.

While not illustrated in FIGS. 3 and 4, the issuer may view (and release) statements based on account number structure and hierarchy. As a general example of this, the issuer may view all statements having an account number in a specified range or having the same or similar account number characteristics (e.g., view all statements having account numbers beginning with the same four or five digits).

FIG. 5 illustrates a screen 510 displayed at the card issuer computer 120 if a statement has been flagged for correction at screen 410 in FIG. 4. As seen, the issuer may enter the corrections to be made (in the form of comments to the processing entity) at box 520. Also, the issuer may specify whether the corrections are to be made only to the specific account flagged, or to all the statements in the group being accessed by the issuer (i.e., all the accounts displayed at screen 410 in FIG. 4). After completion, the data entered at screen 510 is transmitted to statement processing system 110 (through preview system 122) for correction of the designated statements.

While a detailed description of presently preferred embodiments of the invention has been given above, various alternatives, modifications, and equivalents will be apparent to those skilled in the art without varying from the spirit of the invention. For example, while embodiments have been illustrated in connection with statements for credit cardholders, it should be appreciated that the invention may also be used in connection with statements for other kinds of accounts, and for accounts where transactions may be made with presentation instruments or without presentation instruments. Therefore, the above description should not be taken as limiting the scope of the invention, which is defined by the appended claims.

What is claimed is:

1. A method for previewing and delivering financial statements prepared by a transaction processing entity for an issuer, where the statements are previewed by the issuer prior to being delivered by electronic transmission to a cardholder, and where the statements are prepared for electronic transmission to the cardholder with security and delivery features, the method comprising:
providing a statement processing system, the statement processing system being operated by the transaction processing entity;
preparing electronic statements at a statement processing system;
providing a statement previewing system in communication with the statement processing system for the issuer to access the statements prior to being prepared with security and delivery features, the previewing system operated by the transaction processing entity;
providing preview criteria to the previewing system, the criteria defining a group of statements that are to be previewed by the issuer;
providing access to the group of statements for the issuer at the previewing system;
providing correction data from the issuer to the previewing system if corrections to the group of statement are required;
preparing corrected statements at the statement processing system if correction data has been provided to the previewing system; and
electronically transmitting the group of statements to cardholders with the security and delivery features.

2. The method of claim 1, wherein providing access to the group of statements for the issuer at the previewing system comprises providing conditional access.

3. The method of claim 2, wherein conditional access comprises requiring review by more than one person at the issuer.

4. The method of claim 2, wherein conditional access comprises requiring review by more than one person at the issuer, with the previewing system providing a communication from a first person at the issuer to a second person at the issuer in connection with the review by more than one person.

5. The method of claim 2, wherein conditional access comprises automatically transmitting the group of statements to cardholders if correction data is not provided to the previewing system within a predetermined period of time after access to the statements is provided at the previewing system.

6. The method of claim 1, further comprising:
identifying plural batches of statements;
selecting one of the batches, wherein statements from the selected batch are to be previewed; and
applying the preview criteria to the statements in the selected batch.

7. The method of claim 1, wherein the preview criteria is selected by the issuer.

8. The method of claim 7, where the previewing system uses the preview criteria to sort the prepared electronic statements, so that every nth one of the prepared electronic statements is included in the group of statements to be previewed, where n is an integer.

9. The method of claim 7, where the previewing system uses the preview criteria to sort the prepared electronic statements, so that only statements corresponding to delinquent card accounts are included in the group of statements.

10. The method of claim 7, where the previewing system uses the preview criteria to sort the prepared electronic statements, so that only statements for accounts that have interest rates falling with designated ranges are included in the group of statements.

11. A system for preparing and electronically delivering statements to cardholders from a transaction processing entity on behalf of a card issuer, where the statements are previewed by the issuer prior to being delivered by electronic transmission to the cardholder, and where the statements are prepared by the statement processing system for electronic transmission to cardholders with security and delivery features, the method comprising:
a statement processing system operated by the transaction processing entity;
a statement previewing system operated by the transaction processing entity;
a cardholder computer in communication with the statement processing system and used by a cardholder to receive a statement; and
a card issuer computer used by the card issuer to preview statements;
wherein the card issuer uses the card issuer computer to provide preview criteria to the previewing system, the criteria defining a group of statements that are to be previewed by the issuer, wherein the previewing system provides the card issuer computer with access to the group of statements without security and delivery features, wherein the card issuer computer is used by the card issuer to provide correction data to the statement processing system if corrections to the group of statements are specified by the card issuer, wherein the statement processing system prepares corrected statements if correction data has been provided to the previewing system, and wherein the statement processing system electronically transmits the corrected statements to the cardholder computer with security and delivery features.

12. The method of claim 11, wherein the previewing system provides conditional access.

13. The method of claim 12, wherein the conditional access comprises requiring review by more than one person at the issuer.

14. The method of claim 12, wherein conditional access comprises requiring review by more than one person at the issuer, with the previewing system providing a communication from a first person at the issuer to a second person at the issuer in connection with the review by more than one person.

15. The method of claim 12, wherein conditional access comprises automatically transmitting the group of statements to cardholders if correction data is not provided to the previewing system within a predetermined period of time after access to the statements is provided at the previewing system.

16. The method of claim 11, wherein the previewing system identifies several batches of statements, wherein the card issuer selects one of the batches so that statements from the selected batch may be previewed, and wherein the previewing system applies the preview criteria to the statements in the selected batch.

17. The method of claim 11, wherein the preview criteria is selected by the card issuer at the card issuer computer.

18. The method of claim 17, where the previewing system uses the preview criteria to sort the prepared electronic statements, so that every nth one of the prepared electronic statements is included in the group of statements to be previewed, where n is an integer.

19. The method of claim 17, where the previewing system uses the preview criteria to sort the prepared electronic statements, so that only statements corresponding to delinquent card accounts are included in the group of statements.

20. The method of claim 17, where the previewing system uses the preview criteria to sort the prepared electronic statements, so that only statements for accounts that have interest rates falling with designated ranges are included in the group of statements.
